(19) United States
(12) Patent Application Publication
(10) Pub. No.: US 2026/0277399 A1
(43) Pub. Date: Sep. 17, 2026

(54) ELECTRONIC DEVICE AND OPERATION METHOD THEREOF

(71) Applicant: SAMSUNG ELECTRONICS CO., LTD., Suwon-si (KR)

(72) Inventors: Namsu HA, Suwon-si (KR); Yongdeok KIM, Suwon-si (KR); Heeran LEE, Suwon-si (KR)

(73) Assignee: SAMSUNG ELECTRONICS CO., LTD., Suwon-si (KR)

(21) Appl. No.: 19/678,392

(22) Filed: May 15, 2026

Related U.S. Application Data
(63) Continuation of application No. PCT/KR2024/015488, filed on Oct. 14, 2024.

(30) Foreign Application Priority Data
Nov. 15, 2023 (KR) 10-2023-0158620

(51) Int. Cl. G06F 3/0482

(52) U.S. Cl. CPC G06F 3/0482

(57) ABSTRACT

An operating method of an electronic device includes: obtaining a first interaction cost consumed in a case that menu items arranged according to a context-based arrangement method are selected, and a second interaction cost consumed in a case that the menu items arranged according to a count-based arrangement method are selected; and arranging the menu items according to a selected one of the context-based arrangement method or the count-based arrangement method, based on comparing the first interaction cost and the second interaction cost, wherein the context-based arrangement method arranges the menu items, according to a value resulting from applying at least one weight value to a number of selections for each menu item, based on at least one context at a time at which an arrangement request is received.

### CROSS-REFERENCE TO RELATED APPLICATIONS

This application is continuation of International Application No. PCT/KR2024/015488, filed on Oct. 14, 2024, which is based on and claims priority under to Korean Patent Application No. 10-2023-0158620, filed on Nov. 15, 2023, in the Korean Intellectual Property Office, the disclosures of which are incorporated by reference herein in their entireties.

### BACKGROUND

### 1. Field

The disclosure generally relates to an electronic device and an operating method thereof, and more particularly, to an electronic device capable of arranging a menu by selecting one of a plurality of menu arrangement methods and an operating method of the electronic device.

### 2. Description of Related Art

To improve menu usability, in many cases, information about menu items that a user has previously selected on an electronic device is used.

In such cases, the electronic device collects and analyzes the information about the menu items selected by the user on the electronic device and arranges the positions of the menu items according to the frequency of use and importance. However, this approach has a limitation in that the menu items once arranged remain in a fixed form.

However, after the menu items are arranged and provided, information about menu items selected by the user may no longer be reflected in the user's preferences. That is, the user's preferences for using the menu may not reflected in real time.

As the functions of various electronic devices increase, the kinds and number of menu items have also increased. However, input methods have not changed much from using remote controllers, and in many cases, movements and selections are made using 4-way keys. Therefore, the layout of menu items is significant.

### SUMMARY

According to an aspect of the disclosure, an operating method of an electronic device, includes: obtaining a first interaction cost consumed in a case that menu items arranged according to a context-based arrangement method are selected, and a second interaction cost consumed in a case that the menu items arranged according to a count-based arrangement method are selected; and arranging the menu items according to a selected one of the context-based arrangement method or the count-based arrangement method, based on comparing the first interaction cost and the second interaction cost, wherein the context-based arrangement method arranges the menu items, according to a value resulting from applying at least one weight value to a number of selections for each menu item, based on at least one context at a time at which an arrangement request is received.

According to an aspect of the disclosure, an electronic device includes: memory storing one or more instructions; and one or more processors, wherein the one or more instructions, when executed by the one or more processors individually or collectively, cause the electronic device to: obtain a first interaction cost consumed in a case that menu items arranged according to a context-based arrangement method are selected, and a second interaction cost consumed in a case that the menu items arranged according to a count-based arrangement method are selected, and arrange the menu items according to a selected one of the context-based arrangement method or the count-based arrangement method, based on comparing the first interaction cost and the second interaction cost, wherein the context-based arrangement method arranges the menu items, according to a value resulting from applying at least one weight value to a number of selections for each menu item, based on at least one context at a time at which an arrangement request is received.

According to an aspect of the disclosure, a non-transitory computer-readable recording medium stores a program that is executed by one or more processors of an electronic device to perform a method including: obtaining a first interaction cost consumed when menu items arranged according to a context-based arrangement method are selected, and a second interaction cost consumed when the menu items arranged according to a count-based arrangement method are selected; and arranging the menu items according to a selected one of the context-based arrangement method or the count-based arrangement method based on comparing the first interaction cost and the second interaction cost, wherein the context-based arrangement method arranges the menu items, according to a value resulting from applying at least one weight value to a number of selections for each menu item, based on at least one context at a time at which an arrangement request is received.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an example of an operation of an electronic device according to an embodiment;

FIG. 2 is a block diagram illustrating a configuration of an electronic device according to an embodiment;

FIG. 3 is a block diagram for describing in more detail a configuration of an electronic device according to an embodiment;

FIG. 4 is a diagram illustrating an example of calculating an interaction cost according to an embodiment;

FIG. 5 is a flowchart illustrating an operation method of an electronic device according to an embodiment;

FIG. 6 is a diagram illustrating a relationship between software modules in a menu arrangement method according to an embodiment;

FIG. 7 is a flowchart illustrating an example of updating data when an electronic device receives a user input of selecting one of menu items according to an embodiment;

FIG. 8 is a diagram illustrating an example of a method, performed by an electronic device, of arranging menu items based on artificial intelligence according to an embodiment;

FIG. 9 shows an example of a beta distribution graph used in a process, performed by an electronic device, of arranging menu items by using a Multi-Armed Bandit (MAB) algorithm according to a context-based arrangement method;

FIG. 10 is a diagram illustrating an example of using a beta function to generate a beta distribution graph in an electronic device according to an embodiment;

FIG. 11 is a diagram illustrating an example in which an electronic device applies a weight value by using a Gaussian distribution according to a time at which a menu item is selected, according to an embodiment;

FIG. 12 is a diagram illustrating an example in which an electronic device uses a beta function to generate a beta distribution graph by applying a weight value based on information on an application executed at a time at which a menu item is selected according to a context-based arrangement method, according to an embodiment;

FIG. 13 is a diagram illustrating a method, performed by an electronic device, of applying a weight value based on information on an application executed at a time at which a menu item is selected and the time at which the menu item is selected according to a context-based arrangement method, according to an embodiment; and

FIG. 14 is a flowchart illustrating a method, performed by an electronic device, of arranging a menu by dynamically selecting one of a plurality of menu arrangement methods based on a selection history for menu items, according to an embodiment.

### DETAILED DESCRIPTION

Embodiments of the present disclosure will now be described in detail with reference to the accompanying drawings so that those of ordinary skill in the art may readily implement the embodiments. However, the present disclosure may be implemented in various forms, and is not limited to the embodiments described herein.

Although general terms being currently used were selected as terminology used in the present disclosure while considering the functions of the present disclosure, they may mean different terms according to intentions of one of ordinary skill in the art, judicial precedents, the advent of new technologies, and the like. Hence, the terms used in the present disclosure may be interpreted based on the meanings of the terms and the entire content of the present disclosure, rather than based on the names of the terms alone.

The terms used herein are for the purpose of describing particular embodiments and are not intended to limit the scope of the disclosure.

Also, in this specification, it will be understood that the case in which a certain part is “connected” to another part includes the case in which the part is “electrically connected” to the other part with another device in between, as well as the case in which the part is “directly connected” to the other part.

The term “said” and the similar terms used in the present specification may indicate both single and plural. Also, if the order of operations for describing a method according to the present disclosure is not definitely specified, the operations may be performed in appropriate order. However, the present disclosure is not limited to the order in which the operations are described.

The phrases “in some embodiments” or “according to an embodiment” appearing in the present specification do not necessarily indicate the same embodiment.

Embodiments of the present disclosure may be represented by functional block configurations and various processing operations. The functional blocks, in whole or in part, may be implemented with various numbers of hardware and/or software configurations to execute specific functions. For example, the functional blocks of the present disclosure may be implemented with one or more microprocessors, or with circuit configurations for predetermined functions. Also, for example, the functional blocks of the present disclosure may be implemented with various programming or scripting languages. The functional blocks may be implemented with algorithms that are executed by one or more processors. The present disclosure may employ various technologies for electronic environment settings, signal processing, and/or data processing. The terms “mechanism”, “element”, “means”, and “configuration” can be broadly used, and are not limited to mechanical and physical configurations.

Also, connection lines or connection members between components shown in the drawings are examples of functional connections and/or physical or circuital connections. In an actual apparatus, the connections between the components may be implemented in the form of various functional connections, physical connections, or circuital connections that may be replaced or added.

As used in the specification, the terms “portion”, “module”, or the like refers to a unit configured to perform at least one function or operation, and may be implemented as hardware, software, or a combination of hardware and software.

Also, in the specification, the term “user” means a person who controls the functions or operations of an electronic device by using the electronic device.

As used herein, expressions such as “at least one of,” when preceding a list of elements, modify the entire list of elements and do not modify the individual elements of the list. For example, the expression, “at least one of A, B, or C,” should be understood as including only A, only B, only C, both A and B, both A and C, both B and C, or all of A, B, and C.

Hereinafter, embodiments of the present disclosure will be described in detail with reference to the accompanying drawings.

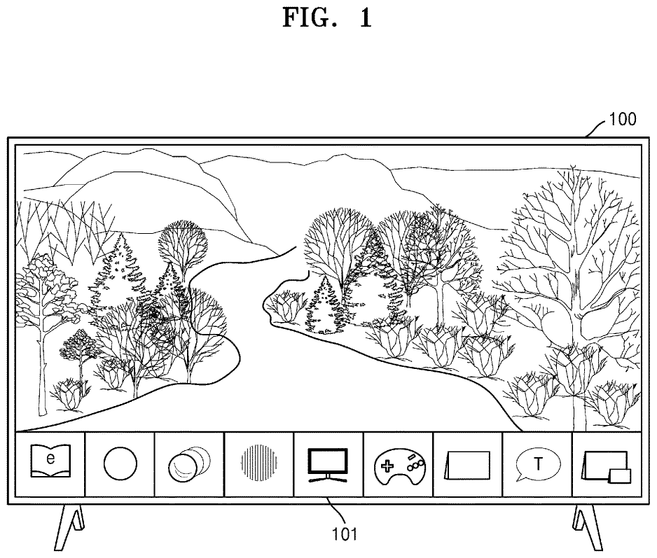

FIG. 1 is a diagram illustrating an example of an operation of an electronic device according to an embodiment.

Referring to FIG. 1, an electronic device 100 may display a menu 101 for receiving an input from a user on a display.

According to an embodiment, the electronic device 100 may be a smart TV, but this is merely one example and the electronic device 100 may be implemented in various forms.

For example, the electronic device 100 may be implemented as a tablet PC, a digital camera, a camcorder, a laptop computer, a netbook computer, a desktop, an e-book reader, a video phone, a digital broadcasting terminal, Personal Digital Assistants (PDA), a Portable Multimedia Player (PMP), a navigation, a wearable device, a smart refrigerator, and other home appliances.

In an embodiment, the electronic device 100 may be readily implemented as an electronic device including a large video output device such as a TV, but the present disclosure is not limited thereto. Also, the electronic device 100 may be of a fixed type or a mobile type and may be a digital broadcast receiver capable of receiving digital broadcasts.

The electronic device 100 may have a built-in display, but is not limited thereto, and may be implemented as a type that operates by being connected to an external display without having a built-in display.

For example, the electronic device 100 may be implemented as a type that outputs images to a separate external display through a video or audio output port, such as an STB, Apple TV, etc., without a display or with a simple display for notifications, etc.

In this case, the electronic device 100 may include an output port for outputting a video or audio signal to the display. The output port may be a type that transmits video signals and audio signals simultaneously, such as High-Definition Multimedia Interface (HDMI), Display Port (DP), and Thunderbolt, or may include separate ports that transmit video signals and audio signals separately.

In an embodiment, the electronic device 100 may transmit video or audio signals through wired communication or wireless communication.

The electronic device 100 may be implemented as an electronic device with a flat display, an electronic device with a curved display having a curvature, or a flexible electronic device having an adjustable curvature. Output definition of the electronic device 100 may include, for example, High Definition (HD), Full HD, Ultra HD, or higher definition than Ultra HD.

As used herein, the term “menu” refers to a set of menu items for receiving a command from a user through various input means by being displayed on the display of the electronic device 100.

A menu may be displayed in various types, such as a pop-up menu, a pull-down menu, etc.

As used herein, the term “menu item” refers to an individual item included in a menu that is selectable by a user.

As used herein, arranging a menu refers to arranging menu items included in the menu.

The electronic device 100 may arrange menu items included in a menu according to various methods.

The electronic device 100 may arrange the menu in real time by dynamically selecting one of a plurality of menu arrangement methods based on information on menu items previously selected by a user.

According to an embodiment, the electronic device 100 may arrange the menu by calculating an interaction cost of each of the plurality of menu arrangement methods based on the information on the menu items previously selected by the user and selecting a menu arrangement method having a small interaction cost. Details about this will be described below.

As used herein, the term “interaction cost” refers to a cost of key operations or a number of key operations consumed for a user to select a specific menu item.

In an embodiment, the interaction cost may increase by a preset value whenever a user is to press an operation key once. The preset value may be, for example, 1.

In an embodiment, the interaction cost may increase by a preset value whenever a user is to press a control key of a remote controller once. The preset value may be, for example, 1.

In an embodiment, the interaction cost may increase by a preset value whenever a user is to press a key once.

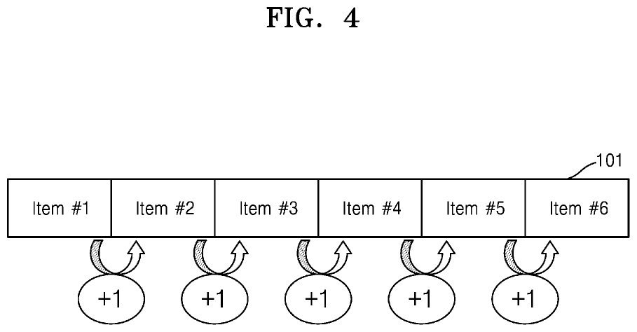

Details about the interaction cost will be described with reference to FIG. 4, below.

The electronic device 100 may, at a time at which a menu arrangement request is received, reflect at least a part of a user's menu item selection history information up to immediately before the time to select an appropriate menu arrangement method in real time and arrange menu items, thereby providing an improved menu that reflects the user's latest menu use history.

In an embodiment, the electronic device 100 may use a context-based menu arrangement method of applying various weight values according to context at a time at which a menu arrangement request is received, as one of various menu arrangement methods, thereby providing an improved menu suitable for the context at the time at which the menu arrangement request is received.

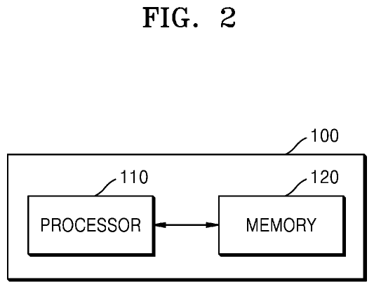

FIG. 2 is a block diagram illustrating a configuration of an electronic device according to an embodiment.

Referring to FIG. 2, the electronic device 100 may include at least one processor 110 (hereinafter, “the processor”) and memory 120.

The memory 120 may store a program for processing and control by the processor 110. Also, the memory 120 may store data input to the electronic device 100 or output from the electronic device 100.

The memory 120 may include at least one of internal memory or external memory. The memory 120 may store control history information, current environmental information, and status information.

The memory 120 may include at least one kind of storage medium among a flash memory type, a hard disk type, a multimedia card micro type, card type memory (for example, Secure Digital (SD) memory or extreme Digital (XD) memory), Random Access Memory (RAM), Static Random Access Memory (SRAM), Read-Only Memory (ROM), Electrically Erasable Programmable Read-Only Memory (EEPROM), and Programmable Read-Only Memory (PROM), magnetic memory, a magnetic disk, or an optical disk.

The internal memory may include at least one among, for example, volatile memory (for example, Dynamic RAM (DRAM), Static RAM (SRAM), and Synchronous Dynamic RAM (SDRAM)), non-volatile memory (for example, One Time Programmable ROM (OTPROM), Erasable and Programmable ROM (EPROM), Electrically Erasable and Programmable ROM (EEPROM), Mask ROM, Flash ROM, etc.), a Hard Disk Drive (HDD), or a Solid State Drive (SSD).

According to an embodiment, the processor 110 may load a command or data received from non-volatile memory or at least one of other components in volatile memory, and process the command or data. Also, the processor 110 may store data received or generated from another component in the non-volatile memory.

The external memory may include at least one among, for example, Compact Flash (CF), Secure Digital (SD), Micro Secure Digital (Micro-SD), Mini Secure Digital (Mini-SD), extreme Digital (xD), or Memory Stick.

The memory 120 may store one or more instructions that are executable by the processor 110.

In an embodiment, the memory 120 may store various information input through an input/output device.

In an embodiment, the memory 120 may store instructions for controlling the processor to receive an arrangement request for menu items, obtain a first interaction cost based on an interaction cost of when the menu items are arranged according to the context-based arrangement method and a second interaction cost based on an interaction cost of when the menu items are arranged according to the count-based arrangement method, arrange the menu items according to the context-based arrangement method based on the first interaction cost being less than the second interaction cost, and arrange the menu items based on the count-based arrangement method based on the first interaction cost being greater than the second interaction cost.

In a case where a user's input is received or a preset, stored condition is satisfied, the processor 110 may execute Operating System (OS) and various applications stored in the memory 120.

The processor 110 may include RAM that stores a signal or data received from outside of the electronic device 100 or is used as a storage area corresponding to various tasks performed on the electronic device 100, and ROM in which a control program for controlling the electronic device 100 is stored.

The processor 110 may include a single core, a dual core, a triple core, a quad core, and a multiple core. Also, the processor 110 may include a plurality of processors. For example, the processor 110 may be implemented with a main processor and a sub processor that operates in a sleep mode.

Also, the processor 110 may include at least one of a Central Processing Unit (CPU), a Graphic Processing Unit (GPU), or a Video Processing Unit (VPU). Alternatively, according to some embodiments, the processor 110 may be implemented in the form of a System On Chip (SOC) into which at least one of CPU, GPU, or VPU is integrated.

The processor 110 may execute one or more instructions stored in the memory 120 to control various components of the electronic device 100.

In an embodiment, the processor 110 may receive an arrangement request for menu items.

In an embodiment, the processor 110 may obtain a first interaction cost based on an interaction cost of when the menu items are arranged according to the context-based arrangement method and a second interaction cost based on an interaction cost of when the menu items are arranged according to the count-based arrangement method.

In an embodiment, based on the first interaction cost being less than the second interaction cost, the processor 110 may arrange the menu items according to the context-based arrangement method, and based on the first interaction cost being greater than the second interaction cost, the processor 110 may arrange the menu items based on the count-based arrangement method.

In an embodiment, the processor 110 may receive a user input of selecting one of the menu items, obtain at least one context at a time at which the user input is received, store a value resulting from multiplying the number of times by which the selected menu item has been selected by at least one weight value determined based on the at least one context, as context-based data for the selected menu item, and store a value resulting from increasing the number of times by which the selected menu item has been selected by 1, as count-based data.

In an embodiment, the processor 110 may receive an arrangement request for the menu items, obtain context-based data and count-based data from storage, and determine whether an interaction cost based on the context-based arrangement method is less than an interaction cost based on the count-based arrangement method.

In an embodiment, based on the interaction cost based on the context-based arrangement method being less than the interaction cost based on the count-based arrangement method, the processor 110 may obtain at least one context at a time at which the arrangement request has been received, arrange the menu according to the context-based arrangement method, and display the arranged menu.

In an embodiment, based on the interaction cost based on the context-based arrangement method being not less than the interaction cost based on the count-based arrangement method, the processor 110 may arrange the menu according to the count-based arrangement method and display the arranged menu.

In an embodiment, the processor 110 may transmit a video signal or an audio signal transmitted from the electronic device 100 to an external display such that the corresponding signal is output on the external display.

In an embodiment, the processor 110 may perform control of receiving an arranged menu from a server and displaying the menu on a display of the electronic device 100.

In an embodiment, when a user's selection for a specific menu item is received, the processor 110 may share, with a server or an external device, information that the user's selection for the corresponding menu item has been made once.

Details about tasks that are executed by the processor 110 will be described below.

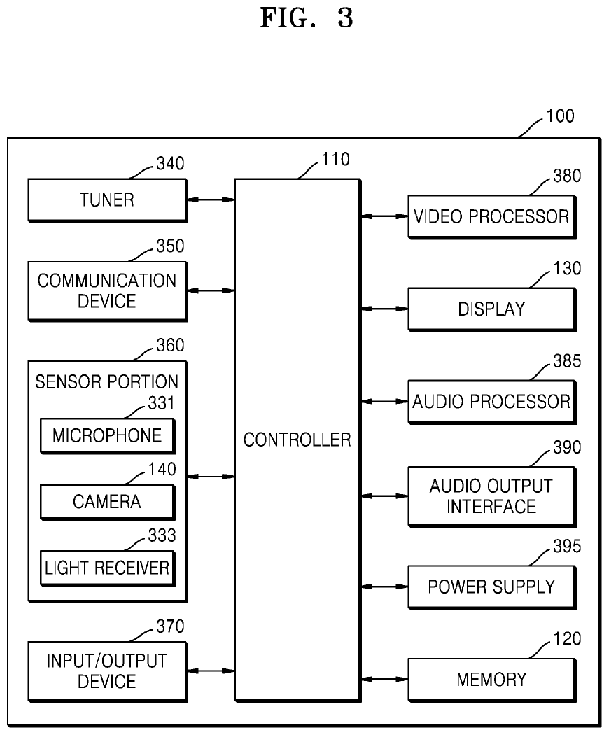

FIG. 3 is a block diagram for describing in more detail a configuration of an electronic device according to another embodiment of the present disclosure.

An electronic device 100 of FIG. 3 may be an embodiment of the electronic device 100 described with reference to FIGS. 1 and 2.

Referring to FIG. 3, the electronic device 100 may include a tuner 340, a processor 110, a display 130, a communication device 350, a sensor portion 360, an input/output device 370, a video processor 380, an audio processor 385, an audio output interface 390, memory 120, and a power supply 395.

The processor 110 of FIG. 3 may correspond to the processor 110 of FIG. 2, and the memory 120 of FIG. 3 may correspond to the memory 120 of FIG. 2. Accordingly, content overlapping with the above-described content will be omitted.

The communication device 350 according to an embodiment may include a Wi-Fi module, a Bluetooth module, an infrared communication module, a wireless communication module, a LAN module, an Ethernet module, a wired communication module, etc. In this case, each communication module may be implemented in a form of at least one hardware chip.

The Wi-Fi module and the Bluetooth module may perform communication based on Wi-Fi and Bluetooth, respectively. In a case in which the Wi-Fi module or the Bluetooth module is used, various connection information, such as a service set identifier (SSID) and a session key, may be first transmitted/received, communication may be established through the connection information, and then various information may be transmitted/received. The wireless communication module may include at least one communication chip that performs communication according to various wireless communication standards, such as zigbee, 3^{rd} Generation (3G), 3^{rd} Generation Partnership Project (3GPP), Long Term Evolution (LTE), LTE Advanced (LTE-A), 4^{th} Generation (4G), and 5^{th} Generation (5G).

The communication device 350 according to an embodiment may receive a user input from an external device 300 such as a user device.

The communication device 350 according to an embodiment may communicate with the external device 300 such as a server.

The communication device 350 according to an embodiment may include a communication device that performs wireless communication such as Bluetooth (BT) with a server, etc. and a communication device connected to an external device through a HDMI port, etc. In this case, the communication device that performs wireless communication such as BT with the server, etc. may establish a connection with another device and perform video/audio data transmission. The communication device connected to the external device 300 through a HDMI port, etc. may include an input port for receiving an input, and an output port, such as DP, HDMI, RGB, Digital Visual Interface (DVI), and Thunderbolt, for transmitting a video or audio signal to an external display, a speaker, etc.

The tuner 340 according to an embodiment may tune and select a frequency of a channel to be received by the electronic device 100 among various radio wave components through amplification, mixing, resonance, etc. of a broadcast signal received by wire or wirelessly. The broadcast signal may include audio, video, and additional information (for example, Electronic Program Guide (EPG)).

The tuner 340 may receive a broadcast signal from various sources, such as terrestrial broadcasting, cable broadcasting, satellite broadcasting, and Internet broadcasting. The tuner 340 may also receive a broadcast signal from sources, such as analog broadcasting or digital broadcasting.

The sensor portion 360 may detect a voice around the electronic device 100, an image around the electronic device 100, or an interaction with surroundings of the electronic device 100, and may include at least one of a microphone 331, a camera 140, or a light receiver 333. The sensor portion 360 may detect a status of the electronic device 100 or a status of the surroundings of the electronic device 100 and transmit detected information to the processor 110.

The microphone 331 may receive a voice uttered by a user and a voice generated from the surroundings of the electronic device 100. The microphone 331 may convert the received voice into an electrical signal and output the electrical signal to the processor 110. The microphone 331 may use various noise removal algorithms to remove noise generated while receiving an external acoustic signal.

The camera 140 may obtain an image frame such as a still image or a moving image. An image captured through an image sensor may be processed through the processor 110 or a separate image processor.

An image frame processed in the camera 140 may be stored in the memory 120 or transmitted to outside through the communication device 350. Two or more cameras 140 may be provided according to a configuration aspect of the electronic device 100.

The light receiver 333 may receive an optical signal (including a control signal) from an external remote controller. The light receiver 333 may receive an optical signal corresponding to a user input (for example, a touch, pressing, a touch gesture, a voice, or a motion) from the remote controller. A control signal may be extracted from the received optical signal according to a control by the processor 110. For example, the light receiver 333 may receive a control signal corresponding to a channel up/down button for channel switching from the remote controller.

The sensor portion 360 of FIG. 3 is shown as including the microphone 331, the camera 140, and the light receiver 333, but is not limited thereto, and may include at least one among a magnetic sensor, an acceleration sensor, a temperature/humidity sensor, an infrared sensor, a gyroscope sensor, a position sensor (for example, a global positioning system (GPS)), an atmospheric pressure, a proximity sensor, a RGB sensor, an illuminance sensor, or a Wi-Fi signal receiver, but is not limited thereto. Functions of the individual sensors may be inferred by one of ordinary skill in the art from their names, and therefore, detailed descriptions thereof are omitted.

The sensor portion 360 of FIG. 3 is shown as being included in the electronic device 100, but is not limited thereto, and may be included in a controller such as a remote controller, which is located independently of the electronic device 100 and communicates with the electronic device 100. In a case where the sensor portion 360 is included in the controller of the electronic device 100, the controller may digitize information detected by the sensor portion 360 and transmit the information to the electronic device 100. The controller may communicate with the electronic device 100 by using short-range communication including infrared, Wi-Fi, or Bluetooth.

For example, the microphone may be included in the electronic device 100, or may also be included in the controller such as a remote controller, which is located independently of the electronic device 100 and communicates with the electronic device 100.

In an embodiment, in a case where the microphone is included in a remote controller, an analog voice signal may be received through the microphone, digitized by the remote controller, and transmitted to the electronic device 100 such as a TV. In this case, the remote controller may communicate with the electronic device 100 through short-range communication including infrared, Wi-Fi, Bluetooth, or BT.

In an embodiment, the electronic device 100 may include a plurality of communication devices 350 that enables various short-range communication including infrared, Wi-Fi, or Bluetooth.

In an embodiment, the electronic device 100 may include a plurality of communication devices 350 in which a communication device for communicating with a server is different from a communication device for communicating with a remote controller. For example, the communication device for communicating with the server may be a communication device using an Ethernet modem, a Wi-Fi module, etc., whereas the communication device for communicating with the remote controller may be a communication device using a BT module.

In an embodiment, the electronic device 100 may include the communication devices 350 in which a communication device for communicating with a server is the same as a communication device for communicating with a remote controller. For example, both the communication device for communicating with the server and the communication device for communicating with the remote controller may be communication devices using Wi-Fi modules.

For example, a device such as a smart phone in which a remote controller application has been installed may perform the same function as the remote controller mentioned above. That is, the device in which the remote controller application has been installed may control the electronic device 100 such as a TV and perform a voice recognition function.

A device in which the remote controller application is installable may be devices, such as an artificial intelligence (AI) speaker, capable of operating by installing an application, as well as a smart phone.

In an embodiment, the device in which the remote controller application has been installed may be capable of receiving a user's voice.

In an embodiment, the electronic device 100 may include a plurality of communication devices capable of implementing the communication methods to transmit/receive data to/from a remote controller or a device in which a remote controller application is installable by using Wi-Fi, BT, infrared, etc. and control the remote controller or the device in which the remote controller application is installable.

The input/output device 370 may receive video (for example, a moving image, etc.), audio (for example, a voice, music, etc.), and additional information (for example, EPG, etc.) from the outside of the electronic device 100 according to control by the processor 110. The input/output device 370 may include any one of a HDMI, a Mobile High-Definition Link (MHL), a Universal Serial Bus (USB), a DP, Thunderbolt, a Video Graphics Array (VGA) port, a RGB port, D-subminiature (D-SUB), a Digital Visual Interface (DVI), a component jack, or a PC port.

The video processor 380 may process video data received by the electronic device 100. The video processor 380 may perform various image processing, such as decoding, scaling, noise filtering, frame rate conversion, and definition conversion, on video data.

The display 130 may generate a driving signal by converting an image signal, a data signal, an On-Screen Display (OSD) signal, a control signal, etc. processed in the processor 110. The display 130 may be implemented as a Plasma Display Panel (PDP), a Liquid Crystal Display (LCD), an Organic Light Emitting Diode (OLED), a flexible display, etc. and may also be implemented as a three-dimensional (3D) display. Also, the display 130 may be configured as a touch screen and used as an input device as well as an output device.

The display 130 may output various content received through the communication device or the input/output device 370, or may output an image stored in the memory 120. Also, the display 130 may output, on a screen, information input by a user through the input/output device 370.

The display 130 may include a display panel. The display panel may be a LCD panel or may be a panel including various light emitting sources, such as LEDs, OLEDS, and cold cathode fluorescent lamps (CCFL). Also, the display panel may include a flat display device, a curved display device having a curved screen, or a flexible display device having an adjustable curvature. The display panel may be a 3D display or an electrophoretic display.

Output definition of the display panel may include, for example, High Definition (HD), Full HD, Ultra HD, or higher definition than Ultra HD.

In the embodiment of FIG. 3, the electronic device 100 is shown as including a display, but is not limited thereto. The electronic device 100 may be connected to a separate display device including a display through wired or wireless communication and transmit a video/audio signal to the display device.

The audio processor 385 may process audio data. The audio processor 385 may perform various processing, such as decoding, amplification, or noise filtering, on audio data. Meanwhile, the audio processor 385 may include a plurality of audio processing modules for processing audio corresponding to a plurality of contents.

The audio output interface 390 may output audio included in a broadcast signal received through the tuner 340 according to control by the processor 110. The audio output interface 390 may output audio (for example, a voice or sound) received through the communication device 350 or the input/output device 370. Also, the audio output interface 390 may output audio stored in the memory 120 according to control by the processor 110. The audio output interface 390 may include at least one of a speaker, a headphone output terminal, or a Sony/Philips Digital Interface (S/PDIF) output terminal.

The power supply 395 may supply power received from an external power source to internal components of the electronic device 100 according to control by the processor 110. Also, the power supply 395 may supply power output from one or more batteries located inside the electronic device 100 to the internal components according to control by the processor 110.

The memory 120 may store various data, programs, or applications for driving and controlling the electronic device 100 according to control by the processor 110. The memory 120 may include a broadcast receiving module, a channel control module, a volume control module, a communication control module, a voice recognition module, a motion recognition module, a light receiving module, a display control module, an audio control module, an external input control module, a power control module, a power control module of an external device connected in a wireless fashion (for example, Bluetooth), voice database (DB), or motion DB. The modules and database of the memory 120 may be implemented in the form of software to perform a broadcast reception control function, a channel control function, a volume control function, a communication control function, a voice recognition function, a motion recognition function, a light reception control function, a display control function, an audio control function, an external input control function, a power control function, or a power control function of an external device connected in a wireless fashion (for example, Bluetooth), in the electronic device 100. The processor 110 may perform the individual functions by using the software stored in the memory 120.

Meanwhile, the block diagram of the electronic device 100 shown in FIGS. 2 and 3 may be for an embodiment. Some components included in the block diagram may be integrated or omitted, or another component may be added, according to an actual specification of the electronic device 100. That is, two or more components may be integrated into one component, or one component may be separated into two or more components. Also, functions performed in the individual blocks are provided to describe embodiments, and detailed operations or devices for the functions do not limit the scope of the present disclosure.

FIG. 4 is a diagram illustrating an example of calculating an interaction cost according to an embodiment.

A menu 101 shown in FIG. 4 may include six menu items Item #1 to Item #6.

In a case where a cursor is on Item #1 when the menu is first executed, the number of key operations for a user to select a menu item may be the smallest for Item #1 and the greatest for Item #6. That is, an interaction cost may increase toward the right from Item #1.

In an embodiment, in a case where an interaction cost of Item #1 is ‘0’, Item #2 may have an interaction cost of ‘1’ because Item #2 uses one more right key operation, Item #3 may have an interaction cost of ‘2’, Item #4 may have an interaction cost of ‘3’, Item #5 may have an interaction cost of ‘4’, and Item #6 may have an interaction cost of ‘5’.

In an embodiment, the electronic device 100 may apply a Multi-Armed Bandit (MAB) algorithm to change an interaction cost of each menu item, such as 1/6 for Item #1, 2/6 for Item #2, 3/6 for Item #3, 4/6 for Item #4, 5/6 for Item #5, and 6/6 for Item #6. This may be because different weight values have been applied according to positions of the respective menu items.

In an embodiment, the electronic device 100 may meaningfully reflect a selection of a distant item to menu arrangement by applying a largest weight value to the distant item and a smallest weight value to a nearby item.

In an embodiment, the electronic device 100 may assign a larger weight value to a menu item that is further away from the cursor, such as assigning a largest weight value to Item #6 which is farthest from the cursor when Item #6 is selected.

The electronic device 100 may increase a learning effect with a small amount of data by applying an interaction cost changed by applying at least one weight value, and, when a user's pattern changes and thus an item located far from the cursor is often used, the electronic device 100 may quickly reflect the change in learning.

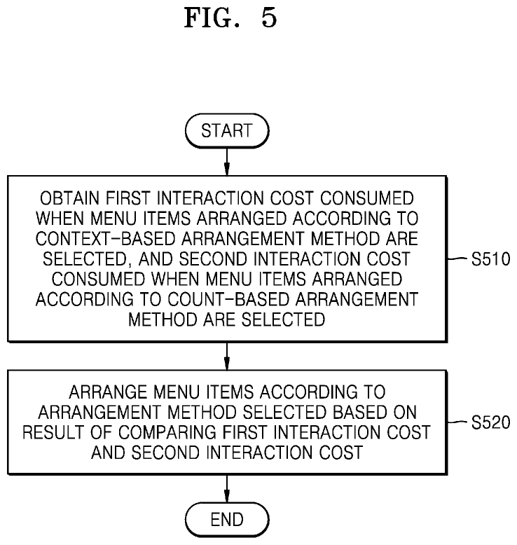

FIG. 5 is a flowchart illustrating an operation method of an electronic device according to an embodiment.

The electronic device 100 may receive an arrangement request for menu items.

In an embodiment, the electronic device 100 may receive the arrangement request for menu items from a user through various input means. The various input means may include at least one of a voice input, a gesture input, an input through an input interface, such as a remote controller, a keyboard, and a mouse, or a text input.

In an embodiment, the electronic device 100 may automatically receive an arrangement request for menu items according to a system setting, not from a user. The arrangement request may be received periodically. In an embodiment, a menu arrangement request may be automatically and continuously received according to an initial setting.

In an embodiment, the electronic device 100 may receive an arrangement request for menu items in real time whenever a menu is displayed. The request may be a request input manually by a user, or a request received automatically according to a system setting.

For example, the electronic device 100 may select any one of an option of automatically arranging a menu in real time on a setting screen, an option of automatically arranging a menu periodically, or an option of automatically arranging a menu only when a user input is made.

The electronic device 100 may obtain a first interaction cost based on an interaction cost of when the menu items are arranged according to a context-based arrangement method and a second interaction cost based on an interaction cost of when the menu items are arranged according to a count-based arrangement method (S510).

The context-based arrangement method may be a method of arranging menu items according to a value resulting from applying at least one weight value to the number of times by which each menu item has been selected, based on at least one context obtained at a time at which an arrangement request is received.

The at least one context may include at least one of a time at which a menu item has been selected, a position of a selected menu item, a time elapsed after a menu item has been selected, or an application executed at a time at which a menu item has been selected.

The at least one weight value may include at least one of a decrement rate at which a relatively smaller weight value is applied the longer a time elapsed after a menu item has been selected, a weight value that is applied differently depending on a time at which a menu item has been selected based on a Gaussian distribution, a weight value that is applied differently depending on a position of a selected menu item, or a weight value that is applied differently depending on an application executed at a time at which a menu item has been selected.

Details about the context-based arrangement method and the weight value will be described below.

The count-based arrangement method may be a method of arranging menu items according to the number of times by which each menu item has been selected.

The count-based arrangement method may be a method of displaying a most-selected menu item at the front and a least-selected menu item at the farthest. That is, the count-based arrangement method may arrange menu items based on selection frequency of each menu item.

Each of the first interaction cost and the second interaction cost may mean an interaction cost consumed for a user to select a recently selected menu item or an average of interaction costs consumed for the user to select menu items that have been selected during a predetermined time period.

Based on the first interaction cost being less than the second interaction cost, the electronic device 100 may arrange the menu items based on the context-based arrangement method, and based on the first interaction cost being greater than the second interaction cost, the electronic device 100 may arrange the menu items according to the count-based arrangement method (S520).

Based on the first interaction cost being equal to the second interaction cost, the electronic device 100 according to an embodiment may arrange the menu items by arbitrarily selecting any one of the context-based arrangement method or the count-based arrangement method. In this case, any method may be selected.

The electronic device 100 according to an embodiment may, at a time at which a menu arrangement request is received, arrange the menu items in real time by reflecting a user's menu item selection history information up to immediately before the time.

The electronic device 100 according to an embodiment may, at a time at which a menu arrangement request is received, select a menu arrangement method having a smallest interaction cost from among various menu arrangement methods by reflecting a user's menu item selection history information up to immediately before the time.

The electronic device 100 may arrange the menu items according to the selected menu arrangement method and display the arranged menu items on the display.

The electronic device 100 may, at a time at which a menu arrangement request is received, arrange the menu items in real time by reflecting a user's menu item selection history information up to immediately before the time, thereby providing a menu that reflects the user's use history.

The electronic device 100 according to an embodiment may provide a menu specialized for each user by reflecting the user's use history. In this case, the electronic device 100 may identify each user by using various user identification methods, such as voice recognition, face recognition, and gesture recognition, and store and use a menu item selection history for each user.

The electronic device 100 according to an embodiment may arrange the menu items by assigning a larger weight value to a more recent use history among the user's menu use histories, thereby providing a menu that reflects the user's recent menu use trend.

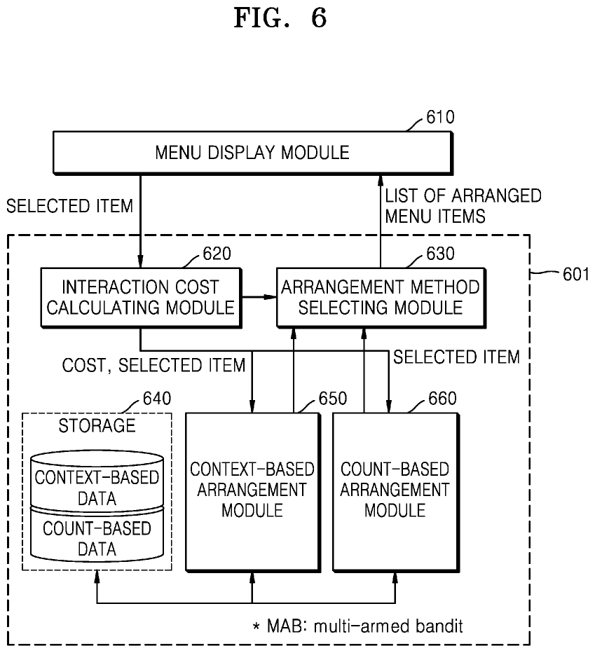

FIG. 6 is a diagram illustrating a relationship between software modules in a menu arrangement method according to an embodiment.

The electronic device 100 according to an embodiment may use various software modules to implement a menu arrangement method according to the present disclosure.

The electronic device 100 according to an embodiment may use a menu display module 610, an interaction cost calculating module 620, an arrangement method selecting module 630, storage 640, a context-based arrangement module 650, and a count-based arrangement module 660.

The menu display module 610 may receive a menu item selected by a user and transmit the menu item to another module.

The menu display module 610 may request the arrangement method selection module 630 to transfer a menu selected from among a menu arranged according to the context-based arrangement method and a menu arranged according to the count-based arrangement method.

The menu display module 610 may receive a list of arranged menu items from the arrangement method selection module 630 and display the list on the display.

The interaction cost calculating module 620 may calculate a cost consumed for a user to select a menu.

The interaction cost calculating module 620 may receive menu item information selected by the user from the menu display module 610 and calculate an interaction cost of the received menu item.

In an embodiment, the interaction cost calculating module 620 may receive menus generated in the context-based arrangement module 650 and the count-based arrangement module 660 and calculate an interaction cost of each menu item.

In an embodiment, the interaction cost calculating module 620 may transmit the calculated interaction cost to the context-based arrangement module 650 and the count-based arrangement module 660.

In an embodiment, the interaction cost calculating module 620 may transmit each calculated interaction cost to the arrangement method selecting module 630.

The arrangement method selecting module 630 may compare an interaction cost of the menu arranged according to the context-based arrangement method with an interaction cost of the menu arranged according to the count-based arrangement method based on the menus arranged in the context-based arrangement module 650 and the count-based arrangement module 660, thereby selecting the menu having a smaller interaction cost.

The arrangement method selecting module 630 may transmit the menu having the smaller interaction cost among the menu arranged according to the context-based arrangement method and the menu arranged according to the count-based arrangement method to the menu display module 610.

The storage 640 may be a software module related to data storage. The storage 640 may receive data from the menu display module 610, the interaction cost calculating module 620, the arrangement method selecting module 630, the context-based arrangement module 650, or the count-based arrangement module 660, and store the data.

The storage 640 may transmit a part or all of the stored data to the menu display module 610, the interaction cost calculating module 620, the arrangement method selecting module 630, the context-based arrangement module 650, or the count-based arrangement module 660.

The storage 640 may store context-based data generated in the context-based arrangement module 650 and count-based data generated in the count-based arrangement module 660.

The storage 640 may store data used or generated in a process of arranging a menu by dynamically selecting one of a plurality of menu arrangement methods based on information about menu items previously selected by the electronic device 100.

The context-based arrangement module 650 may be a software module that arranges menu items by applying at least one weight value to the number of times by which each menu item has been selected, based on data received from the storage and at least one context obtained at a time at which a context arrangement request has been received.

The context-based arrangement module 650 may store an arranged menu or data generated in a menu arrangement process in the storage 640.

In an embodiment, the context-based arrangement module 650 may use an interaction cost to arrange the menu items.

In an embodiment, the context-based arrangement module 650 may use a pre-trained deep neural network model to arrange the menu items. Details about this will be described below.

The count-based arrangement module 660 may arrange the menu items according to the number of times by which each menu item has been selected, that is, use frequency of the menu items, obtained from the storage 640. The count-based arrangement module 660 may store an arranged menu or data generated in a menu arrangement process in the storage 640.

The electronic device 100 according to an embodiment may arrange the menu items by using a MAB algorithm.

The MAB algorithm refers to a class of algorithms widely used in recommendation systems, analogous to determining which slot machine among several slot machines to pull to increase rewards through exploration and exploitation.

In an embodiment, the electronic device 100 may use the MAB algorithm to determine which menu arrangement method among various menu arrangement methods is most efficient to arrange a menu.

In an embodiment, a MAB algorithm module 601, which is a set of software modules used in the MAB algorithm, may include the interaction cost calculating module 620, the arrangement method selecting module 630, the storage 640, the context-based arrangement module 650, and the count-based arrangement module 660.

Some of the modules of FIG. 6 may be integrated or omitted, or another module may be added according to embodiments.

That is, two or more modules may be integrated into one module or one module may be subdivided into two or more modules. Also, functions that are performed in the individual modules are provided to describe embodiments, and detailed operations or devices therefor do not limit the scope of the present disclosure.

In an embodiment, the software modules of FIG. 6 may be provided in a server, not in the electronic device 100. In this case, when a user's selection of a menu item is made, the electronic device 100 may transmit the selection to the server, receive an arranged menu from the server, and display the arranged menu.

In an embodiment, a part of the software modules of FIG. 6 may be provided in the electronic device 100 and the remaining part may be provided in the server. In this case, the electronic device 100 may arrange menu items through data transmission/reception to/from the server.

For example, the electronic device 100 may include the menu display module 610, the interaction cost calculating module 620, and the arrangement method selection module 630, and the server may include the storage 640, the context-based arrangement module 650, and the count-based arrangement module 660.

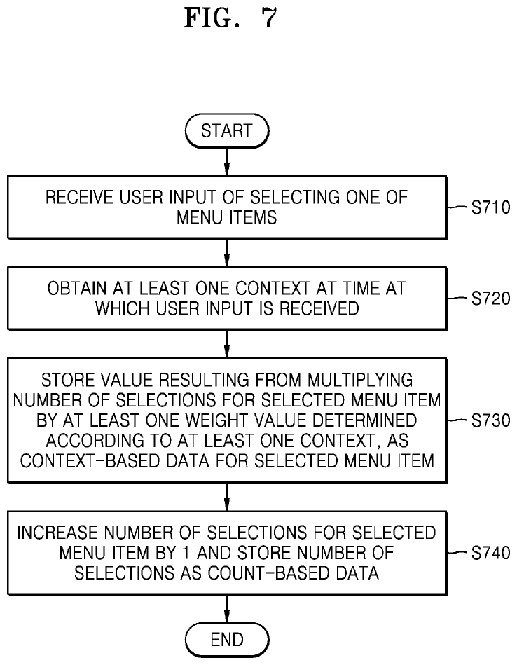

FIG. 7 is a flowchart illustrating an example of updating data when an electronic device receives a user input of selecting one of menu items according to an embodiment.

The electronic device 100 may receive a user input of selecting one of menu items (S710).

In an embodiment, the electronic device 100 may receive an input of selecting one of menu items from a user through a voice command.

In an embodiment, the electronic device 100 may receive an input of selecting one of menu items from a user through an external device, such as a remote controller, a keyboard, a mouse, etc.

In an embodiment, the electronic device 100 may receive an input of selecting one of menu items from a user through a wired or wireless network.

The electronic device 100 may identify the menu item selected by the user from among the menu items.

The electronic device 100 may obtain at least one context at a time at which the user input has been received (S720).

The at least one context may include at least one among a time at which the menu item has been selected, a position of a selected menu item, a time elapsed after a menu item has been selected, or an application executed at a time at which a menu item has been selected.

In an embodiment, the electronic device 100 may store, as context-based data for the selected menu item, a value resulting from multiplying the number of selections for the selected menu item by at least one weight value determined according to the at least one context (S730).

In an embodiment, the at least one weight value may include at least one among a decrement rate at which a relatively smaller weight value is applied the longer a time elapsed after a menu item has been selected, a weight value that is applied differently depending on a time at which a menu item has been selected using a Gaussian distribution, a weight value that is applied differently depending on a position of a selected menu item, or a weight value that is applied differently depending on an application executed at a time at which a menu item has been selected.

In an embodiment, the electronic device 100 may store the value resulting from multiplying the number of times by which the menu item has been selected by the at least one weight value determined according to the at least one context, in the storage.

In an embodiment, the storage may be memory or database included in the electronic device 100, or external database.

The electronic device 100 may increase the number of selections for the selected menu item by 1 and store the number of selections as count-based data (S740).

The electronic device 100 may update the storage by increasing the number of selections for the selected menu item by 1.

In an embodiment, the storage may be memory or database included in the electronic device 100, or external database.

In the current embodiment, operation S740 of updating count-based data has been described as being performed after operations S720 and S730 of updating context-based data, but is not limited thereto. Operation S740 of updating count-based data may be first performed and then operations S720 and S730 of updating context-based data may be performed, or operation S740 of updating count-based data may be performed simultaneously with operations S720 and S730 of updating context-based data.

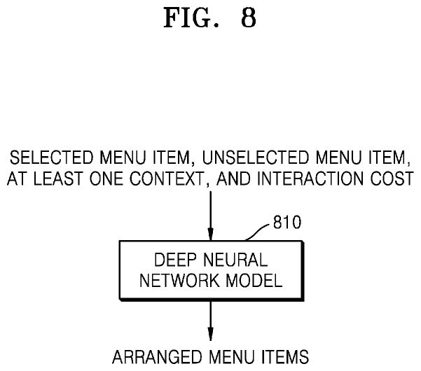

In an embodiment, the electronic device 100 may use the context-based data stored according to the embodiment of FIG. 7 in the context-based arrangement method such as an example shown in FIGS. 8 to 13.

In an embodiment, the electronic device 100 may use the count-based data stored according to the embodiment of FIG. 7 in the count-based arrangement method.

FIG. 8 is a diagram illustrating an example of a method, performed by an electronic device, of arranging menu items based on artificial intelligence according to an embodiment.

A method of arranging menu items by using artificial intelligence may be used in the context-based arrangement method.

The electronic device 100 may use a neural network 810 trained to receive a selected menu item, an unselected menu item, at least one context, and an interaction cost as inputs and output arranged menu items.

The selected menu item may mean a menu item selected by a user, and the unselected menu item may mean a menu item not selected by a user.

The at least one context may include at least one of a time at which a menu item has been selected, a position of a selected menu item, a time elapsed after a menu item has been selected, or an application executed at a time at which a menu item has been selected.

In an embodiment, the interaction cost may be an interaction cost consumed for a user to select a most recently selected menu item from a menu arranged according to the context-based arrangement method.

In an embodiment, the interaction cost may mean an average of interaction costs consumed for a user to select previously selected menu items respectively from a menu arranged according to the context-based arrangement method.

In an embodiment, the electronic device 100 may obtain a menu arranged automatically by the context-based arrangement method by using the selected menu item, the unselected menu item, the at least one context, and the interaction cost.

The artificial intelligence is a computer system which implements human-level intelligence, in which machines learn and make judgements on their own, and of which recognition rate is improved with use. Artificial intelligence technology is configured with machine learning (deep learning) technology that uses algorithms that classify/learn the characteristics of input data on their own, and element technologies that use machine learning algorithms to simulate recognition and judgment functions of the human brain.

For example, the element technologies may include at least one among linguistic understanding technology that recognizes human language/characters, visual understanding technology that recognizes objects as if human vision does, inference/prediction technology that judges information and makes logical inference and prediction, knowledge representation technology that processes human experience information as knowledge data, or motion control technology that controls autonomous driving of vehicles and movements of robots.

An artificial intelligence-related function according to the present disclosure may operate through the processor 110 and memory 120. The processor 110 may be composed of a single or plurality of processors. In this case, the single or plurality of processors may be a general-purpose processor, such as a CPU, Application Processor (AP), and Digital Signal Processor (DSP), a graphics-dedicated processor such as a GPU and VPU, or an artificial intelligence-dedicated processor such as a Neural Processing Unit (NPU). The single or plurality of processors 110 may perform control of processing input data according to a predefined operation rule or artificial intelligence model stored in the memory 120. Also, when the single or plurality of processors 110 are an artificial intelligence-dedicated processor, the artificial intelligence-dedicated processor may be designed with a hardware structure specialized for processing a specific artificial intelligence model.

The predefined operation rule or artificial intelligence model may be generated through training. Here, being generated through training may mean that a predefined operation rule or artificial intelligence model set to perform a desired characteristic (or purpose) is generated by training a basic artificial intelligence model with a plurality of pieces of training data according to a learning algorithm. The training may be performed in the electronic device 100 that performs artificial intelligence according to the present disclosure or through a separate server 200 and/or system. An example of the learning algorithm may include supervised learning, unsupervised learning, semi-supervised learning, or reinforcement learning, but is not limited thereto.

The artificial intelligence model may be configured with a plurality of neural network layers. Each of the plurality of neural network layers may have a plurality of weight values, and perform neural network computation through computation between a computation result of a previous layer and the plurality of weight values. The plurality of weight values of the plurality of neural network layers may be improved by a training result of the artificial intelligence model. For example, the plurality of weight values may be updated such that loss values or cost values obtained from the artificial intelligence model during a training process are reduced.

In an embodiment using a deep learning algorithm, the processor 110 may obtain a menu arranged by the context-based arrangement method by using a pre-trained deep neural network 810. The pre-trained deep neural network 810 may be an artificial intelligence model trained through learning of receiving a selected menu item, an unselected menu item, at least one context, and an interaction cost as input values and outputting an arrangement menu as an output value.

The deep neural network model may be, for example, a Convolutional Neural Network (CNN), but is not limited thereto. The deep neural network model may be a known artificial intelligence model including at least one among a Recurrent Neural Network (RNN), a Restricted Boltzmann Machine (RBM), a Deep Belief Network (DBN), a Bidirectional Recurrent Deep Neural Network (BRDNN), or a Deep Q-Network.

The electronic device 100 may obtain an arranged menu through various other machine learning algorithms by applying at least one weight value based on current context.

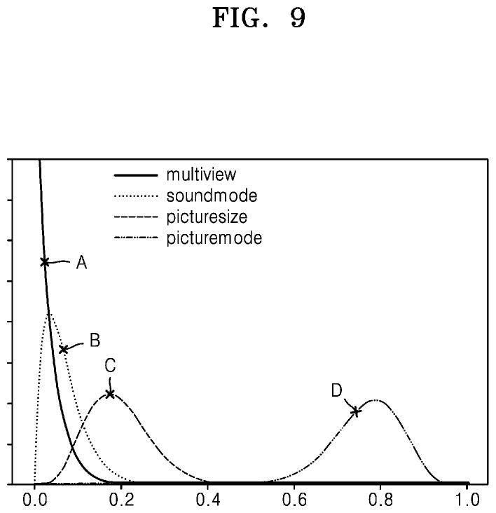

FIG. 9 shows an example of a beta distribution graph used in a process, performed by an electronic device according to an embodiment of the present disclosure, of arranging menu items by using a MAB algorithm according to a context-based arrangement method.

The electronic device 100 according to an embodiment may arrange menu items by using the MAB algorithm.

The MAB algorithm is an algorithm using a similar way to finding out which slot machine to pull among several slot machines to increase profits through exploration and exploitation, and widely used in recommendation systems.

The MAB algorithm may be implemented by various methods. For example, the MAB algorithm may be implemented as an E-greedy algorithm, an Upper Confidence Bound (UCB) algorithm, or a Thompson Sampling algorithm.

In an embodiment, the electronic device 100 may arrange the menu items according to an order in which the menu items are recommended based on the Thompson Sampling algorithm.

The Thompson Sampling algorithm may be an algorithm that uses a probability distribution (beta distribution) instead of directly estimating a reward.

The Thompson Sampling algorithm may arrange an order of menu items by extracting random variables with expected reward values between 0 and 1 from probability distributions of the respective menu items and comparing magnitudes of the extracted expected reward values.

In FIG. 9, A, B, C, and D may be random variables extracted from probability distributions of menu items. A, B, C, and D may have expected reward values between 0 and 1.

In this case, an expected reward of each menu item may mean a probability that the menu item will be selected by a user.

In an embodiment, the electronic device 100 may probabilistically predict expected rewards for the menu items by using beta distributions to generate beta distribution graphs as shown in FIG. 9, randomly extract a value (random variable) from the beta distribution of each menu item, and compare extracted values with each other, thereby arranging the menu items in descending order of the expected rewards.

An X axis of FIG. 9 may represent expected reward values between 0 and 1. In this case, the closer an expected reward value of a certain menu item is to 1, the more likely the menu item will be selected by the user.

The respective graphs including A, B, C and D of FIG. 9 may correspond to the respective menu items.

In an embodiment, the electronic device 100 may compare the values randomly extracted from the beta distributions of the respective menu items, thereby arranging an order of the menu items.

In an embodiment, the electronic device 100 may arrange the menu items in an order in which the values randomly extracted from the beta distributions of the respective menu items are closer to 1.

The closer a value randomly extracted from a beta distribution is to 1, the more likely a menu item corresponding to the value will be selected by a user.

In the embodiment of FIG. 9, the electronic device 100 may arrange the menu items in an order of D, C, B, and A based on proximity to 1. That is, the electronic device 100 may arrange the menu items by locating the menu item corresponding to D which is most likely to be selected by the user, at a most accessible position, and arranging the menu item corresponding to C, the menu item corresponding to B, and the menu item corresponding to A in this order.

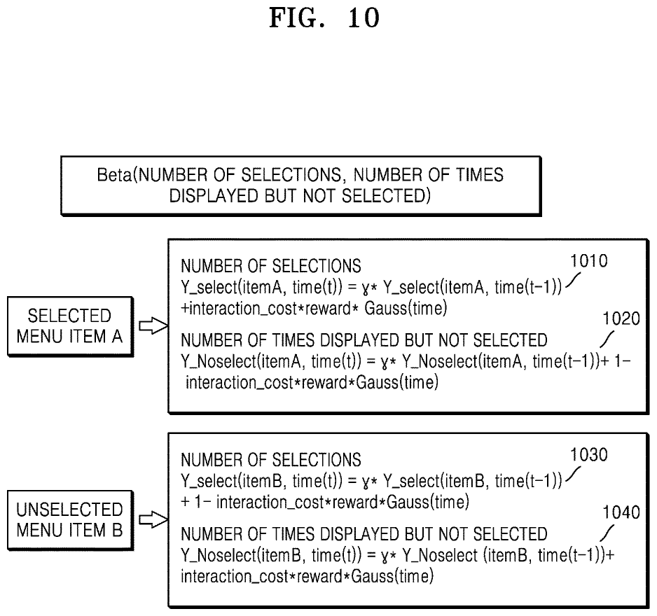

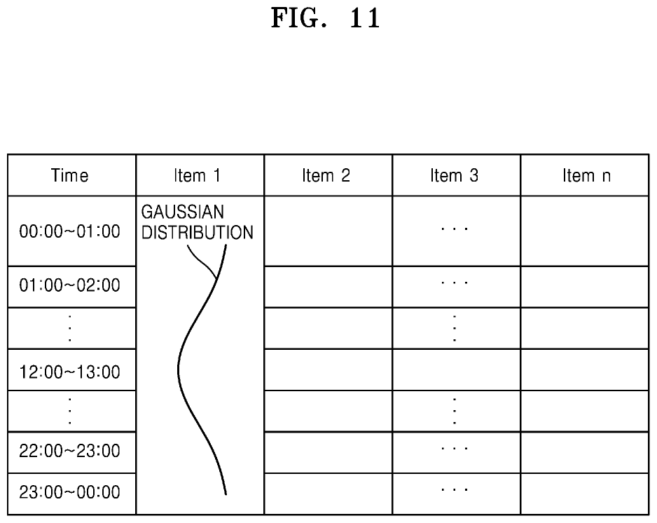

FIGS. 10 and 11 illustrate an example of a process of using a beta distribution to probabilistically predict an expected reward for each menu item when context is a continuous concept such as “time at which a menu item has been selected” in the context-based arrangement method.

A beta distribution is a continuous probability distribution defined in a section between 0 and 1 depending on two parameters, and a beta function may be used to calculate a beta distribution.

FIG. 10 is a diagram illustrating an example of using a beta function to generate a beta distribution graph in an electronic device according to an embodiment.

In an embodiment, in a case where a beta function is represented as Beta (x, y), x may represent the number of times by which the corresponding menu item has been selected, and y may represent the number of times by which the corresponding menu item has been displayed but not selected.

The context-based arrangement method may arrange menu items by applying at least one weight value according to at least one context to the number of times by which each menu item has been selected.

In an embodiment, the electronic device 100 may apply three types of weight values to the number of selections for a selected menu item A, and a calculation formula 1010 may be used.

In a case where weight values are not taken into account, the number of selections for the menu item A may increase by 1, as in [(number of selections for menu item A at time t)=(number of selections for menu item A at time t−1)+1].

Among weight values applied in the formula 1010, γ may be a decrement rate at which a relatively smaller weight value is applied the longer a time elapsed after a menu item has been selected. The number of selections calculated at a time t may be influenced by the number of selections before the time t. However, in order to reflect a user's recent menu use pattern, the number of selections made a long time ago may need to be reflected a small weight value, and the number of selections made recently may need to be reflected a large weight value.

In an embodiment, when a user's menu use pattern changes, the electronic device 100 may decrease weight values for existing values at an arbitrary rate for a quick response. γ may mean such a decrement rate.

In an embodiment, the decrement rate may be a value between 0 and 1. In an embodiment, the decrement rate may be a negative value.

When the decrement rate is used, as data is accumulated and a time elapsed after a menu is selected increases, the number of previous selections may be reflected a smaller weight.

In the formula 1010, a reward may means a reward value for a selection of a menu item.

In the formula 1010, the electronic device 100 may compensate for disadvantage according to a position of a menu item by multiplying an interaction cost by a reward. That is, when a menu item with a larger interaction cost is selected, the electronic device 100 may reflect a larger weight value to the corresponding menu item to relatively greatly reflect the number of selections, and when a menu item with a smaller interaction cost is selected, the electronic device 100 may reflect a smaller weight value to the corresponding menu item to relatively less reflect the number of selections.

In the formula 1010, Gauss (time) may mean a Gaussian distribution used to assign a weight value according to a time at which a menu item has been selected by considering that when a specific menu item has been frequently selected in a specific time zone, the same menu item is mostly selected in a similar time zone.

In an embodiment, when a menu item is selected in a time zone at which the corresponding menu item has been frequently used, the electronic device 100 may apply a larger weight value, and when the corresponding menu item is selected in a time zone that is farther away from the time zone in which the menu item has been frequently used, the electronic device 100 may apply a smaller weight value.

FIG. 11 is a diagram illustrating an example in which an electronic device applies a weight value by using a Gaussian distribution according to a time at which a menu item is selected, according to an embodiment.

In the embodiment of FIG. 11, it is confirmed that Item 1 has been mostly selected between 12:00 and 13:00 based on a Gaussian distribution. When Item 1 is selected between 12:00 and 13:00, the electronic device 100 may apply a relatively large weight value in calculating the number of selections for Item 1 in the formula 1010 of FIG. 10.

For example, when a menu item is selected in a time zone in which the corresponding menu item has been frequently used, Gauss (time) may be 1 in the formula 1010 of FIG. 10. When the corresponding menu item is selected in a time zone other than the time zone in which the corresponding menu item has been frequently used, Gauss (time) may be smaller than 1.

In an embodiment, the electronic device 100 may apply the three types of weight values in calculating a value y for a selected menu item A, that is, the number of times by which the menu item A has been displayed but not selected, and a calculation formula 1020 may be used.

In a case where no weight value is applied to calculate the number of times by which the menu item A has been displayed but not selected, the number of times by which the menu item A has been displayed but not selected may be calculated as [(number of times by which menu item A has been displayed but not selected at time t)=(number of times by which menu item A has been displayed but not selected at time t−1)+1−(number of selections for menu item A at time t)].

In an embodiment, the electronic device 100 may apply the three types of weight values in calculating an x value for an unselected menu item B, that is, the number of selections, and a calculation formula 1030 may be used.

In an embodiment, the electronic device 100 may apply the three types of weight values in calculating a y value for the unselected menu item B, that is, the number of times by which the menu item B has been displayed but not selected, and a calculation formula 1040 may be used.

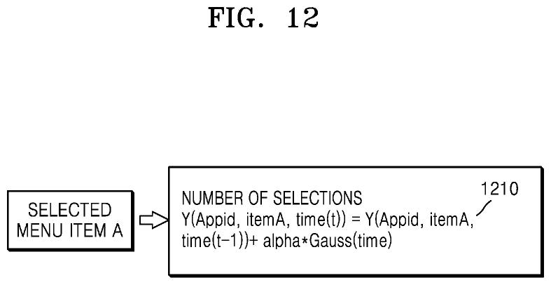

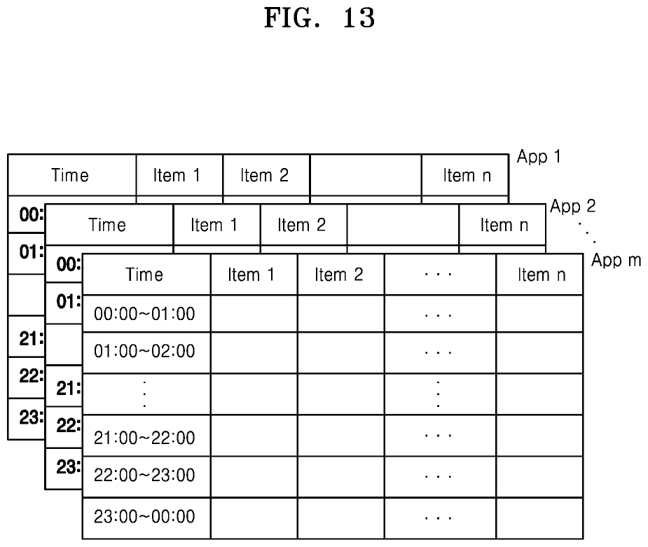

FIGS. 12 and 13 illustrate an example of a process of using a beta distribution to probabilistically predict an expected reward for each menu item when context is not a continuous concept, such as “information on an application executed at a time at which a menu item has been selected”, in the context-based arrangement method.

FIG. 12 is a diagram illustrating an example in which an electronic device uses a beta function to generate a beta distribution graph by applying a weight value based on information on an application executed at a time at which a menu item is selected according to a context-based arrangement method, according to an embodiment.

In a case where a beta function is represented as Beta (x, y), x may represent the number of times by which the corresponding menu item has been selected, and y may represent the number of times by which the corresponding menu item has been displayed but not selected.

The context-based arrangement method may arrange menu items by applying at least one weight value according to at least one context to the number of times by which each menu item has been selected.

In an embodiment, the electronic device 100 may apply three types of weight values to the number of selections for a selected menu item A, and a calculation formula 1210 may be used.

In a case where weight values are not taken into account, the number of selections for the menu item A may increase by 1, as in [(number of selections for menu item A at time t)=(number of selections for menu item A at time t−1)+1].

Among weight values applied in the formula 1210, an interaction cost may compensate for disadvantage according to a position of each menu item. That is, as a menu item with a larger interaction cost is selected, the electronic device 100 may reflect a larger weight value to the corresponding menu item, thereby relatively greatly reflecting the number of selections.

In the formula 1210, Gauss (time) may mean a Gaussian distribution used to assign a weight value according to a time at which a menu item has been selected by considering that when a specific menu item has been frequently selected in a specific time zone, the same menu item is mostly selected in a similar time zone.

In an embodiment, when a menu item is selected in a time zone in which the corresponding menu item has been frequently used, the electronic device 100 may apply a larger weight value, and when the corresponding menu item is selected in a time zone that is farther away from the time zone in which the menu item has been frequently used, the electronic device 100 may apply a smaller weight value.

Content about Gauss (time) may be the same as that described with reference to FIG. 11.

Among weight values applied to the formula 1210, alpha may mean assigning a weight value according to an application executed at a time at which a menu item is selected by considering that when a specific menu item has been frequently selected while a specific application has been executed, the same menu item is mostly selected while the corresponding application is executed.

In an embodiment, the electronic device 100 may apply a larger weight value when a menu item frequently selected while a specific application has been executed is selected, and apply a smaller weight value when another menu item being not the frequently selected menu item is selected.

In an embodiment, alpha may be a value between 0 and 1. In an embodiment, alpha may be a negative value.

FIG. 13 is a diagram illustrating a method, performed by an electronic device, of applying a weight value based on information on an application executed at a time at which a menu item is selected and the time at which the menu item is selected according to a context-based arrangement method, according to an embodiment of the present disclosure.

In an embodiment, the electronic device 100 may assign a weight value by considering both an application executed at a time at which a menu item is selected and the time at which the menu item is selected.

In an embodiment, the electronic device 100 may apply a larger weight value when a menu item frequently selected when a specific application has been executed is selected, and may apply a smaller weight value when another menu item being not the frequently selected menu item is selected.

In an embodiment, the electronic device 100 may apply a larger weight value when a menu item is selected in a time zone in which the corresponding menu item has been frequently used, and may apply a smaller weight value when the corresponding menu item is selected in a time zone that is farther away from the time zone in which the menu item has been frequently used.

In an embodiment, when a menu item frequently selected while a specific application has been executed is selected and the corresponding menu item is selected in a time zone in which the corresponding menu item has been frequently used, the electronic device 100 may apply a larger weight value than when the menu item frequently selected while the specific application has been executed is selected and the corresponding menu item is selected in another time zone being not the time zone at which the corresponding menu item has been frequently used, or when another menu item not being the menu item frequently selected while the specific application has been executed is selected and the corresponding menu item is selected in the time zone in which the corresponding menu item has been frequently used.

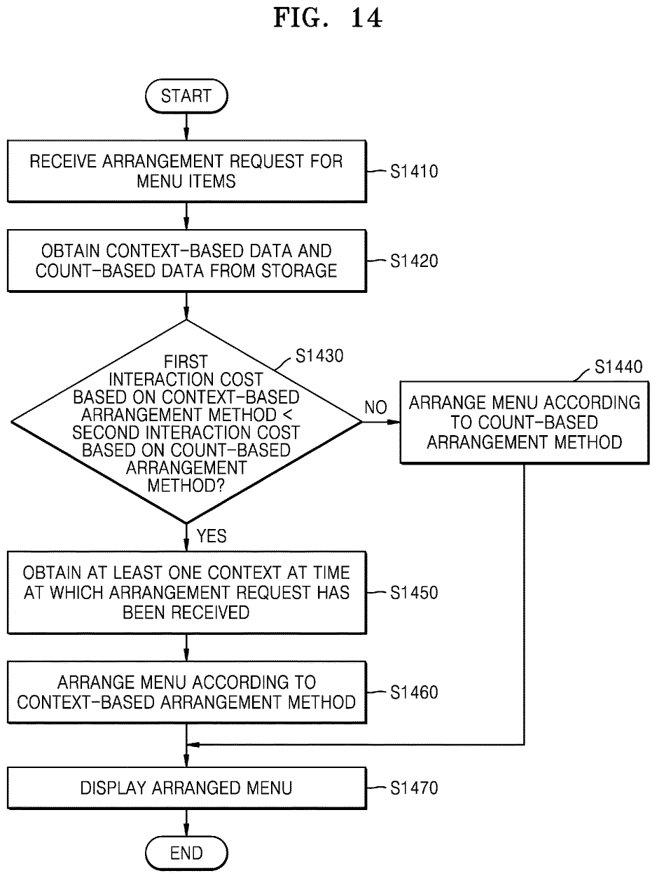

FIG. 14 is a flowchart illustrating a method, performed by an electronic device, of arranging a menu by dynamically selecting one of a plurality of menu arrangement methods based on a selection history for menu items, according to an embodiment.

The electronic device 100 may receive an arrangement request for menu items from a user (S1410).

In an embodiment, the electronic device 100 may receive a voice command or a gesture command from a user, as the arrangement request for the menu items.

In an embodiment, the electronic device 100 may receive the arrangement request for the menu items through an external device, such as a remote controller, a keyboard, and a mouse.

In an embodiment, the electronic device 100 may receive the arrangement request for the menu items from a user through a wired or wireless network.

The electronic device 100 may obtain context-based data and count-based data from the storage (S1420).

In an embodiment, the context-based data and count-based data obtained from the storage may be data stored according to the flowchart of FIG. 7.

In an embodiment, the storage may be memory or database included in the electronic device 100, or external database.

In an embodiment, the electronic device 100 may process data stored in the storage to generate new context-based data and count-based data.

The electronic device 100 may compare a first interaction cost based on the context-based arrangement method with a second interaction cost based on the count-based arrangement method to determine whether the first interaction cost is less than the second interaction cost (S1430).

In an embodiment, the electronic device 100 may calculate the first interaction cost based on the context-based arrangement method and the second interaction cost based on the count-based arrangement method based on the context-based data and count-based data obtained in operation S1420.

In an embodiment, the electronic device 100 may obtain the first interaction cost based on an interaction cost for arrangement according to the context-based arrangement method.

In an embodiment, the electronic device may obtain the second interaction cost based on an interaction cost for arrangement according to the count-based arrangement method.

In an embodiment, the first interaction cost may be an interaction cost consumed for a user to select a most recently selected menu item from a menu arranged according to the context-based arrangement method.

In an embodiment, the second interaction cost may be an interaction cost consumed for a user to select a most recently selected menu item from a menu arranged according to the count-based arrangement method.

In an embodiment, the first interaction cost may mean an average of interaction costs consumed for a user to select previously selected menu items from a menu arranged according to the context-based arrangement method.

In an embodiment, the second interaction cost may mean an average of interaction costs consumed for a user to select previously selected menu items from a menu arranged according to the count-based arrangement method.

Based on the first interaction cost being greater than or equal to the second interaction cost, the electronic device 100 may arrange a menu according to the count-based arrangement method (S1440).

In this case, the menu items may be arranged from a menu item frequently selected by a user to a menu item infrequently selected by a user.

Based on the first interaction cost being less than the second interaction cost, the electronic device 100 may obtain at least one context at a time at which the menu arrangement request has been received (S1450).

The at least one context may include at least one among a time at which a menu item has been selected, a position of a selected menu item, a time elapsed after a menu item has been selected, or an application executed at a time at which a menu item has been selected.

The electronic device 100 may arrange the menu according to the context-based arrangement method (S1460).

In an embodiment, the electronic device 100 may arrange the menu according to the context-based arrangement method such as the example shown in FIGS. 8 to 13.

The electronic device 100 may display the arranged menu (S1470).

The electronic device 100 may display the menu arranged according to the context-based arrangement method or the count-based arrangement method.

In an embodiment, in a case where a method having a low interaction cost is selected by evaluating the context-based arrangement method and the count-based arrangement method in real time as in FIG. 14, the count-based arrangement method may be often adopted in an initial stage when a user's menu use history is insufficient, and the context-based arrangement method may be often adopted as the user's menu use history is accumulated.

The method of operating the electronic device, as shown in FIGS. 1 to 14, may be shared not only by the electronic device 100, but also by one or more other electronic devices that are used with the same user account or determined to be used by the same user through user identification.

That is, one or more other electronic devices that are used with the same user account or determined to be used by the same user through user identification may share data stored in the storage and arrange a menu according to synchronized criteria.

Furthermore, the number of selections for a menu item selected by any of one or more electronic devices that are used with the same user account or determined to be used by the same user through user identification may be increased on the devices.

The method of operating the electronic device 100 according to an embodiment may be implemented in the form of a computer-readable medium including an instruction that is executable by a computer, such as a program module that is executed by a computer. The computer-readable medium may be an arbitrary available medium which is able to be accessed by a computer, and may include a volatile or non-volatile medium and a separable or non-separable medium. The computer-readable medium may also include, alone or in combination with program commands, data files, data structures, and the like. Program commands recorded in the medium may be the kind designed and constructed for the present disclosure or available to those of ordinary skill in the computer software field. Examples of the computer-readable media include magnetic media, such as hard disks, floppy disks, and magnetic tapes, optical media, such as compact disc read only memory (CD-ROM) and digital video disc (DVD), magneto-optical media such as floptical disks, and hardware devices, such as read only memory (ROM), random access memory (RAM), flash memory, and the like, configured to store and execute program commands. Examples of the program commands include high-level language codes that may be executed on a computer through an interpreter or the like, as well as machine language codes produced by a compiler.

According to an embodiment, the method according to various embodiments disclosed in the present document may be included in a computer program product and provided. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store or between two user devices (e.g., smart phones) directly. When distributed online, at least part of the computer program product (e.g., a downloadable app) may be temporarily generated or at least temporarily stored in the machine-readable storage medium, such as a memory of the manufacturer's server, a server of the application store, or a relay server.

The above-described embodiments are for illustrative purposes, and it will be apparent that those of ordinary skill in the art may make various modifications thereto without changing the technical spirit and features of the disclosure. Thus, it should be understood that the embodiments described above are merely for illustrative purposes and not for limitation purposes in all aspects. For example, each component described as a single type may be implemented in a distributed type, and components described as distributed may be implemented in a combined form.

A method of operating an electronic device may include receiving an arrangement request for menu items, obtaining a first interaction cost based on an interaction cost of when the menu items are arranged according to a context-based arrangement method, and a second interaction cost based on an interaction cost of when the menu items are arranged according to a count-based arrangement method, arranging the menu items based on the context-based arrangement method according to the first interaction cost being less than the second interaction cost, and arranging the menu items based on the count-based arrangement method according to the first interaction cost is larger than the second interaction cost, wherein the context-based arrangement method may be a method of arranging the menu items according to a value resulting from applying at least one weight to the number of times by which each menu item has been selected, based on at least one context obtained at a time at which the arrangement request is received, and the count-based arrangement method may be a method of arranging the menu items according to the number of times by which each menu item has been selected.

Each of the first interaction cost and the second interaction cost may mean an interaction cost consumed for a user to select a last selected menu item, or an average of interaction costs consumed for a user to select menu items that have been selected.

The at least one context may include at least one among a time at which a menu item has been selected, a position of a selected menu item, a time elapsed after a menu item has been selected, or an application executed at a time at which a menu item has been selected.

The context-based arrangement method may use a neural network trained to receive, as inputs, a selected menu item, an unselected menu item, the at least one context, and the first interaction cost, and output arranged menu items.

The context-based arrangement method may arrange the menu items by using various Multi-Armed Bandit (MAB) algorithms.

The method of operating the electronic device may further include receiving a user input of selecting one of the menu items, obtaining at least one context at a time at which the user input is received, storing a value resulting from multiplying the number of selections for the selected menu item by the at least one weight value determined according to the at least one context, as context-based data for the selected menu item, and increasing the number of selections for the selected menu item by 1 and storing the number of selections as count-based data.

The context-based data may be used to arrange the menu items according to the context-based arrangement method, and the count-based data may be used to arrange the menu items according to the count-based arrangement method.

The at least one weight may include a decrement rate at which a smaller weight value is applied the longer a time elapsed after a menu item has been selected.

The at least one weight value may include at least one among a weight value that is applied differently depending on a time at which a menu item has been selected based on a Gaussian distribution, a weight value that is applied differently depending on a position of a selected menu item, or a weight value that is applied differently depending on an application executed at a time at which a menu item has been selected.

The at least one weight value may include the weight value that is applied differently depending on the position of the selected menu item.

An electronic device may include memory storing one or more instructions, and one or more processors configured to execute the one or more instructions stored in the memory to cause the electronic device to receive an arrangement request for menu items, obtain a first interaction cost based on an interaction cost of when the menu items are arranged according to a context-based arrangement method, and a second interaction cost based on an interaction cost of when the menu items are arranged according to a count-based arrangement method, arrange the menu items based on the context-based arrangement method according to the first interaction cost being less than the second interaction cost, and arrange the menu item based on the count-based arrangement method according to the first interaction cost being greater than the second interaction cost, wherein the context-based arrangement method may be a method of arranging the menu items, according to a value resulting from applying at least one weight value to the number of selections for each menu item, based on at least one context at a time at which the arrangement request is received, and the count-based arrangement method may be a method of arranging the menu items according to the number of selections for each menu item.

Each of the first interaction cost and the second interaction cost may mean an interaction cost consumed for a user to select a last selected menu item, or an average of interaction costs consumed for a user to select menu items that have been selected.

The at least one context may include at least one among a time at which a menu item has been selected, a position of a selected menu item, a time elapsed after a menu item has been selected, or an application executed at a time at which a menu item has been selected.

The context-based arrangement method may use a neural network trained to receive, as inputs, a selected menu item, an unselected menu item, the at least one context, and the first interaction cost, and output arranged menu items.

The context-based arrangement method may arrange the menu items by using various Multi-Armed Bandit (MAB) algorithms.

The one or more processors may be configured to execute the one or more instructions to receive a user input of selecting one of the menu items, obtain at least one context at a time at which the user input is received, store a value resulting from multiplying the number of selections for the selected menu item by the at least one weight value determined according to the at least one context, as context-based data for the selected menu item, and increase the number of selections for the selected menu item by 1 and store the number of selections as count-based data.

The context-based data may be used to arrange the menu items according to the context-based arrangement method, and the count-based data may be used to arrange the menu items according to the count-based arrangement method.

The at least one weight may include a decrement rate at which a smaller weight value is applied the longer a time elapsed after a menu item has been selected.

The at least one weight value may include at least one among a weight value that is applied differently depending on a time at which a menu item has been selected based on a Gaussian distribution, a weight value that is applied differently depending on a position of a selected menu item, or a weight value that is applied differently depending on an application executed at a time at which a menu item has been selected.

A computer-readable recording medium storing a program for performing the method of operating the electronic device on a computer may be provided.

What is claimed is:

1. An operating method of an electronic device, the operating method comprising:
obtaining a first interaction cost consumed in a case that menu items arranged according to a context-based arrangement method are selected, and a second interaction cost consumed in a case that the menu items arranged according to a count-based arrangement method are selected; and
arranging the menu items according to a selected one of the context-based arrangement method or the count-based arrangement method, based on comparing the first interaction cost and the second interaction cost,
wherein the context-based arrangement method arranges the menu items, according to a value resulting from applying at least one weight value to a number of selections for each menu item, based on at least one context at a time at which an arrangement request is received.

2. The operating method of claim 1, wherein each of the first interaction cost and the second interaction cost is an interaction cost corresponding to a number of key operations for selecting a most recently selected menu item, or an average interaction cost for selecting menu items that have been previously selected.

3. The operating method of claim 1, wherein the at least one context comprises at least one among a time at which a menu item has been selected, a position of a selected menu item, a time elapsed after a menu item has been selected, or an application executed at a time at which a menu item has been selected.

4. The operating method of claim 1, wherein the context-based arrangement method uses a neural network trained to receive, as inputs, a selected menu item, an unselected menu item, the at least one context, and the first interaction cost, and output arranged menu items.

5. The operating method of claim 1, wherein the context-based arrangement method arranges the menu items by using at least one Multi-Armed Bandit (MAB) algorithm.

6. The operating method of claim 1, further comprising:
receiving a user input of selecting one of the menu items;
obtaining at least one context at a time at which the user input is received;
storing a value resulting from multiplying the number of selections for a selected menu item by the at least one weight value determined according to the at least one context, as context-based data for the selected menu item; and
increasing the number of selections for the selected menu item by 1 and storing the number of selections as count-based data.

7. The operating method of claim 1, wherein the count-based arrangement method arranges the menu items based on a number of times each menu item has been selected, and
wherein the arranging the menu items according to the selected one of the context-based arrangement method or the count-based arrangement method comprises:
arranging the menu items based on the context-based arrangement method based on to the first interaction cost being less than the second interaction cost, and
arranging the menu items based on the count-based arrangement method based on to the first interaction cost being greater than the second interaction cost.

8. The operating method of claim 1, wherein the at least one weight value comprises a decrement rate at which a smaller weight value is applied the longer a time elapsed after a menu item has been selected.

9. The operating method of claim 1, wherein the at least one weight value comprises at least one of a weight value that is applied differently depending on a time at which a menu item has been selected based on a Gaussian distribution, a weight value that is applied differently depending on a position of a selected menu item, or a weight value that is applied differently depending on an application executed at a time at which a menu item has been selected.

10. The operating method of claim 9, wherein the at least one weight value comprises the weight value that is applied differently depending on the position of the selected menu item.

11. An electronic device comprising:
memory storing one or more instructions; and
one or more processors,
wherein the one or more instructions, when executed by the one or more processors individually or collectively, cause the electronic device to:
obtain a first interaction cost consumed in a case that menu items arranged according to a context-based arrangement method are selected, and a second interaction cost consumed in a case that the menu items arranged according to a count-based arrangement method are selected, and
arrange the menu items according to a selected one of the context-based arrangement method or the count-based arrangement method, based on comparing the first interaction cost and the second interaction cost,
wherein the context-based arrangement method arranges the menu items, according to a value resulting from applying at least one weight value to a number of selections for each menu item, based on at least one context at a time at which an arrangement request is received.

12. The electronic device of claim 11, wherein each of the first interaction cost and the second interaction cost is an interaction cost corresponding to a number of key operations for selecting a most recently selected menu item, or an average interaction cost for selecting menu items that have been previously selected.

13. The electronic device of claim 11, wherein the at least one context comprises at least one among a time at which a menu item has been selected, a position of a selected menu item, a time elapsed after a menu item has been selected, or an application executed at a time at which a menu item has been selected.

14. The electronic device of claim 11, wherein the context-based arrangement method uses a neural network trained to receive, as inputs, a selected menu item, an unselected menu item, the at least one context, and the first interaction cost, and output arranged menu items.

15. The electronic device of claim 11, wherein the context-based arrangement method arranges the menu items by using at least one Multi-Armed Bandit (MAB) algorithm.

16. The electronic device of claim 11, wherein the one or more instructions, when executed by the one or more processors individually or collectively, cause the electronic device to:
receive a user input of selecting one of the menu items;
obtain at least one context at a time at which a user input of selecting one of the menu items is received;
store a value resulting from multiplying the number of selections for a selected menu item by the at least one weight value determined according to the at least one context, as context-based data for the selected menu item; and
increase the number of selections for the selected menu item by 1 and storing the number of selections as count-based data.

17. The electronic device of claim 11, wherein the count-based arrangement method arranges the menu items based on a number of times each menu item has been selected, and
wherein the one or more instructions, when executed by the one or more processors individually or collectively, cause the electronic device to:
arrange the menu items based on the context-based arrangement method based on to the first interaction cost being less than the second interaction cost, and
arrange the menu items based on the count-based arrangement method based on to the first interaction cost being greater than the second interaction cost.

18. The electronic device of claim 11, wherein the at least one weight value comprises a decrement rate at which a smaller weight value is applied the longer a time elapsed after a menu item has been selected.

19. The electronic device of claim 11, wherein the at least one weight value comprises at least one of a weight value that is applied differently depending on a time at which a menu item has been selected based on a Gaussian distribution, a weight value that is applied differently depending on a position of a selected menu item, or a weight value that is applied differently depending on an application executed at a time at which a menu item has been selected.

20. A non-transitory computer-readable recording medium storing a program that is executed by one or more processors of an electronic device to perform a method comprising:
obtaining a first interaction cost consumed when menu items arranged according to a context-based arrangement method are selected, and a second interaction cost consumed when the menu items arranged according to a count-based arrangement method are selected; and
arranging the menu items according to a selected one of the context-based arrangement method or the count-based arrangement method based on comparing the first interaction cost and the second interaction cost,
wherein the context-based arrangement method arranges the menu items, according to a value resulting from applying at least one weight value to a number of selections for each menu item, based on at least one context at a time at which an arrangement request is received.
